(19) United States
(12) Patent Application Publication
(10) Pub. No.: US 2016/0119789 A1
(43) Pub. Date: Apr. 28, 2016

(54) AUTOMATIC UNLOCKING METHOD AND SYSTEM FOR MOBILE TERMINAL WITHIN SHORT DISTANCE

(71) Applicant: Huizhou TCL Mobile Communication Co., Ltd., Huizhou, Guangdong (CN)

(72) Inventors: Binghui HU, Huizhou, Guangdong (CN); Jie ZHANG, Huizhou, Guangdong (CN)

(73) Assignee: HUIZHOU TCL MOBILE COMMUNICATION CO., LTD., Huizhou, Guangdong (CN)

(21) Appl. No.: 14/891,328

(22) PCT Filed: Sep. 11, 2014
(86) PCT No.: PCT/CN2014/086305

§ 371 Date: Nov. 14, 2015

(30) Foreign Application Priority Data
Jun. 24, 2014 (CN) 201410285438.9

(51) Int. Cl. H04W 12/08; H04W 4/00; H04W 4/02

(52) U.S. Cl. CPC H04W 12/08; H04W 4/023; H04W 4/008

(57) ABSTRACT

The present disclosure discloses an automatic unlocking method and system for a mobile terminal within a short distance. An ID (identity) verification code match is performed in advance between the mobile terminal and a wearable device. The mobile terminal detects, after its screen is locked, whether there is the wearable device that has been performed the ID verification code match. When there is the wearable device detected, then it is determined that whether the distance between the mobile terminal and the wearable device is within a predetermined distance range, if it is within the predetermined distance range, then the mobile terminal is automatically unlocked and entered into the operation interface. The present disclosure makes possible easy use of a mobile terminal when a wearable device is used meanwhile, which brings about profound convenience.

### FIELD OF THE DISCLOSURE

The present disclosure relates to the field of mobile communication, and in particular, to an automatic unlocking method and system for a mobile terminal within a short distance.

### BACKGROUND OF THE DISCLOSURE

With the increasing popularity of mobile terminals, people's lives are getting closer and closer to mobile terminals. However, a mobile terminal in the prior art is not enabled with automatic unlocking functionality, and additionally, in order to turn on the phone, especially in high-efficiency work, it would be needed to swipe in the touch area or enter a passcode in order to unlock the phone, which is extremely inconvenient.

Therefore, the prior art has yet to be improved and developed.

### SUMMARY OF THE DISCLOSURE

The primary technical problem the present disclosure attempting to solve is, directing at the above mentioned deficiencies existing in the prior art, to provide a method of unlocking a mobile terminal within a short distance without adding extra costs and components. The unlocking method is employed with automatic intelligent technologies, which does not add to extra costs and makes operations simple and convenient with high reliability.

A technical solution adopted by the present disclosure in order to solve the technical problem is as following:
an automatic unlocking method for a mobile terminal within a short distance, which comprises the following steps:
performing in advance an ID verification code match between the mobile terminal and a wearable device, for utilizing the wearable device to unlock the mobile terminal;
when a screen of the mobile terminal is locked, utilizing by the mobile terminal a low frequency signal to search within a first recognition area whether there is a wearable device that has been performed the ID verification code match.
if the mobile terminal utilizes the low frequency signal to search within the first recognition area that there is the wearable device that has been performed the ID verification code match, determining by the mobile terminal whether the distance between the mobile terminal and the wearable device is within a predetermined distance range;
if the mobile terminal utilizes the low frequency signal to search within the first recognition area that there is not the wearable device that has been performed the ID verification code match, utilizing by the mobile terminal a high frequency signal to search within a second recognition area whether there is the wearable device that has been perform the ID verification code match;
if the mobile terminal utilizes the high frequency signal to search within the second recognition area that there is the wearable device that has been performed the ID verification code match, determining by the mobile terminal whether the distance between the mobile terminal and the wearable device is within a predetermined distance range;
when the distance between the mobile terminal and the wearable device is determined to be within the predetermined distance range, unlocking by the mobile terminal and entering an operation interface; and
when the distance between the mobile terminal and the wearable device is determined to be not within the predetermined distance range, prompting by the mobile terminal for manual unlocking.

An automatic unlocking method for a mobile terminal within a short distance, which comprises the following steps:
performing in advance an ID verification code match between the mobile terminal and a wearable device, for utilizing the wearable device to unlock the mobile terminal;
when a screen of the mobile terminal is locked, detecting by the mobile terminal whether there is the wearable device that has been performed the ID verification code match;
when the mobile terminal detects that there is the wearable device that has been performed the ID verification code match, determining by the mobile terminal whether the distance between the mobile terminal and the wearable device is within a predetermined distance range; and
when the distance between the mobile terminal and the wearable device is determined to be within the predetermined distance range, unlocking automatically by the mobile terminal and entering an operation interface.

An automatic unlocking system for a mobile terminal within a short distance, comprising:
a presetting module, being configured to perform in advance an ID verification code match between the mobile terminal and a wearable device, for utilizing the wearable device to unlock the mobile terminal;
a detection module, being configured to, when a screen of the mobile terminal is locked, detect by the mobile terminal whether there is a wearable device that has been performed the ID verification code match;
a determining module, being configured to, when the mobile terminal detects that there is the wearable device that has been performed the ID verification code match, determine by the mobile terminal whether the distance between the mobile terminal and the wearable device is within a predetermined distance range; and
an automatic unlocking control module, being configured to, when the distance between the mobile terminal and the wearable device is determined to be within the predetermined distance range, unlock by the mobile terminal and enter an operation interface.

In summary, concerning the automatic unlocking method and system for a mobile terminal within a short distance according to the present disclosure, the mobile terminal detects whether there is a wearable device that has been performed the ID verification code match when the screen of the mobile terminal is locked, and determines whether the distance between the mobile terminal and the wearable device is within a predetermined distance range when it detects the wearable device that has been performed the ID verification code match, and unlocks automatically and enters the home screen when the distance between the mobile terminal and the wearable device is determined to be within the predetermined distance range. Thus, the mobile terminal is enabled with automatic unlocking function, which eliminates the need of repeated manual unlocking in frequent use of mobile terminals and further allows easy use of mobile terminals for a user who meanwhile uses a wearable device, thereby bringing profound convenience to daily use of mobile terminals.

### BRIEF DESCRIPTION OF THE DRAWINGS

FIG. 1 is a flow chart diagram of an automatic unlocking method for a mobile terminal within a short distance according to an embodiment of the present disclosure.

FIG. 2 is a flow chart diagram of an automatic unlocking method for a mobile terminal within a short distance according to a specific example of the present disclosure.

FIG. 3 is a block diagram of an automatic unlocking system for a mobile terminal within a short distance in accordance with the automatic unlocking method for a mobile terminal within a short distance according to the present disclosure.

### DETAILED DESCRIPTION OF THE DISCLOSURE

In order to make the purposes and technical solutions and advantages of the present disclosure clear and definite, a detailed description will be made on the present disclosure with reference to the accompanying drawings and cited embodiments. It should be appreciated that the specific embodiments described herein are merely used to illustrate but not to limit the present disclosure.

In the following description, specific embodiments of the present disclosure will be described with reference to steps or symbols executed by one or more computers, unless otherwise stated. Therefore, these steps and operations will be mentioned more than once to be executed by computers. The computer operations referred to herein comprise operations performed by computer processing units, which represents electronic signals of the data within a structured type. These operations transform the data or maintain the data in the memory system of the computer, wherein the data can be reconfigured or otherwise change the functioning of the computer through means well known by one of ordinary skill in the art. The data structure maintained by the data is the physical location of the memory. The data structure comprises particular characteristics defined by the data format. Although the principles of the present disclosure are illustrated by the above text, it should not be construed as a limit to the present disclosure. One of ordinary skill in the art will understand that the steps and operations described below can also be implemented by hardware.

The principles of the present disclosure may be performed by utilizing a number of other general-purposed or special-purposed operation environments, communication environments or configurations. Examples of well known operation systems, operation environments and configurations applicable to the present disclosure can comprise, but are not limited to, hand-held phones, personal computers, servers, multi-processor systems, micro-computer based systems, main frame computers and distributed computing environments containing any of the above mentioned systems or apparatuses.

The term “module” can be regarded as software objects executed on the computing system. The various components, modules, engines and services described herein can be regarded as objects implemented in the computing system. And the apparatuses and methods described herein are preferably implemented in the form of software, and can be without doubt implemented by hardware, both falling within the scope of claim of the present disclosure.

An automatic unlocking method for a mobile terminal within a short distance according to an embodiment of the present disclosure comprises the following steps:

S100: performing in advance a one-to-one ID (identity) verification code match between the mobile terminal and a wearable device, for utilizing the wearable device to unlock the mobile terminal.

In this embodiment, it needs to perform a one-to-one ID verification code match between the mobile terminal and the wearable device, for utilizing the wearable device to control unlock the mobile terminal, i.e., to set on the mobile terminal a wearable device for auto-sensing unlocking of the mobile terminal. The wearable device can be a wearable watch of the user.

S200: when a screen of the mobile terminal is locked, detecting by the mobile terminal whether there is a wearable device that has been performed the ID verification code match.

That is to say, when the screen of the mobile terminal is locked, the mobile terminal detects whether there is a wearable device around that has been performed the ID verification code match.

S300: if the mobile terminal detects the wearable device that has been performed the ID verification code match, determining by the mobile terminal whether the distance between the mobile terminal and the wearable device is within a predetermined distance range.

The predetermined distance range in the present embodiment can be set to be within 1 meter.

S400: when the distance between the mobile terminal and the wearable device is determined to be within a predetermined distance range, unlocking by the mobile terminal and entering an operation interface.

That is, in this embodiment, when the distance between the mobile terminal and the wearable device is determined to be within 1 meter, the mobile terminal is automatically unlocked and entered the operation interface. The operation interface entered can be a main screen of the mobile terminal, for example, a main screen corresponding to the Home button. Actually, the operation interface entered can also be the previous operation interface before the mobile terminal enters the lock screen. For example, when the user is browsing websites, the screen turns off due to the screen timeout, the operation interface entered when the screen is unlocked should come back to the previous website browsing interface.

Further, when the distance between the mobile terminal and the wearable device is determined to be not within the predetermined distance range, the mobile terminal prompts for manual unlocking. That is, when the distance between the mobile terminal and the wearable device is determined to be not within 1 meter, the mobile terminal prompts for manual unlocking.

A further detailed description will be made on the methods according to the present disclosure with reference to specific embodiments:

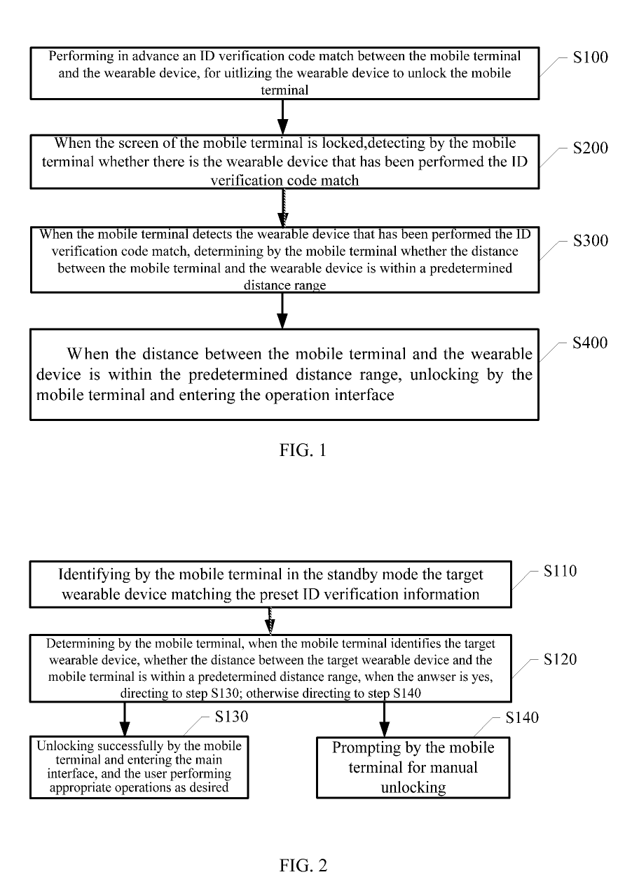

Referring to FIG. 2, which is a flow chart diagram of an automatic unlocking method for a mobile terminal within a short distance according to a preferred example of the present disclosure. The automatic unlocking method for a mobile terminal within a short distance as shown in FIG. 2 comprises the following steps:

S110: identifying by the mobile terminal in the standby mode the target wearable device matching the preset ID verification information.

S120: determining by the mobile terminal, after the mobile terminal identifies the target wearable device, whether the distance between the target wearable device and the mobile terminal is within a predetermined distance range, when the answer is yes, directing to step S130; otherwise, directing to step S140.

S130: unlocking successfully by the mobile terminal and entering a main screen. The user can perform appropriate operations as needed.

S140: when the distance between the mobile terminal and the wearable device is determined to be not within the predetermined distance range, prompting by the mobile terminal for manual unlocking.

In the automatic unlocking method for a mobile terminal within a short distance according to this particular embodiment, the step S110 further comprises the following steps:
A1: utilizing firstly by the mobile terminal a low frequency signal to search within a first recognition area whether there is the target wearable device matching the ID verification code. If the answer is yes, directing to step S120; otherwise directing to step A2;
A2: utilizing by the mobile terminal a high frequency signal to search within a second recognition area whether there is the target wearable device matching the ID verification code. If the answer is yes, directing to step S120; otherwise returning to step S110.

Wherein, the step S120 in this embodiment further comprises the following steps:
B1: determining by the mobile terminal that, after the mobile terminal identifies the target wearable device, when the distance between the target wearable device and the mobile terminal is within a first recognition area, directing to the step S130; or within a second recognition area, directing to step B2;
B2: entering by the mobile terminal into a manual unlocking interface and directing to the step S130 after the mobile terminal is unlocked manually by the user.

Additionally, the present embodiment further comprises the step of, before the step S110, presetting one-to-one ID verification information between the wearable device and the mobile terminal, and storing the preset ID verification information.

Preferably, in the step A1, the mobile terminal firstly utilizes the low frequency signal to search within the first recognition area whether there is the target wearable device matching the ID verification code, the searching time of the first recognition area should be no more than 2 seconds, so as to ensure that, when there is not the target wearable device within the first recognition area, the mobile terminal can terminate the search with the low frequency signal and enter a subsequent step, thus avoiding unnecessary power consumption and effectively improving the pairing efficiency.

In this automatic unlocking method for a mobile terminal within a short distance, the ID verification between the wearable device and the target mobile terminal is performed via a Bluetooth sensor.

It should be noted that the above mentioned embodiment generally initiates the search on the mobile terminal side, thus capitalizing on the large power capacity of the mobile terminal and guaranteeing the operation sustainability and avoiding too fast draining of the wearable device if the search is initiated by the wearable device. In addition, the search can be also initiated on the wearable device side, and the step S110 may be replaced by the following steps:
A1′: utilizing firstly by the wearable device a low frequency signal to search within a first recognition area whether there is the target mobile terminal that has been performed the ID verification code match. If the answer is yes, directing to step C; otherwise directing to step A2′;
A2′: utilizing by the wearable device a high frequency signal to search within a second recognition area whether there is the target mobile terminal matching the ID verification code. If the answer is yes, directing to the step C; otherwise, entering the standby mode;

In the step A1′ of the automatic unlocking method for a mobile terminal within a short distance, the wearable device firstly utilizes the low frequency signal to search within the first recognition area whether there is the target mobile terminal matching the ID verification code, and the searching time of the first recognition area should be not more than 2 seconds.

As is ready to understand, using the wearable device to initiate the search may improve the solution's flexibility and enable intelligent and active searching of and pairing with a mobile terminal according to the actions of the user, thus avoiding initiation of aimless searching of the mobile terminal.

The first recognition area is the automatic unlocking area, and the second recognition area is the manual unlocking area. Allowing for the effective transmission and reception range of the intelligent Bluetooth sensor employed in the present embodiment, the first recognition area is from 0.2 to 1 meter, and the second recognition area is greater than 1 meter. This ensures smooth data exchange within the effective range, thus enabling the method of the present disclosure to be secure and reliable within the effective range and precluding conditions where operations may fail and the paring cannot be achieved.

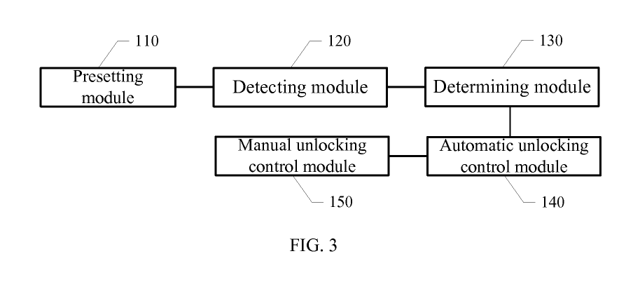

Based on the contents of the above embodiment, the present disclosure further provides an automatic unlocking system for a mobile terminal within a short distance, the system comprising, as is shown in FIG. 3:
an presetting module 110, being configured to perform in advance a one-to-one ID verification code match between the mobile terminal and a wearable device, for utilizing the wearable device to unlock the target mobile terminal; for detailed description, please see above.
a detection module 120, being configured to, when a screen of the mobile terminal is locked, detect by the mobile terminal whether there is the wearable device that has been performed the ID verification code match; for detailed description, please see above.
a determining module 130, being configured to, when the mobile terminal detects the wearable device that has been performed the ID verification code match, determine by the mobile terminal whether the distance between the mobile terminal and the wearable device is within a predetermined distance range; for detailed description, please see above.
an automatic unlocking control module 140, being configured to, when the distance between the mobile terminal and the wearable device is determined to be within the predetermined distance range, unlock by the mobile terminal and enter an operation interface; for detailed description, please see above.
a manual unlocking control module 150, being configured to, when the distance between the mobile terminal and the wearable device is determined to be not within the predetermined distance range, prompt by the mobile terminal for manual unlocking; for detailed description, please see above.

In the automatic unlocking system for a mobile terminal within a short distance, the predetermined distance is 1 meter.

Additionally, the determining module 130 comprises:
a first search control unit, being configured to control the mobile terminal firstly utilize a low frequency signal to search within the first recognition area whether there is the target wearable device that has been performed the ID verification code match; for detailed description, please see above.
a second search control unit, being configured to, when the mobile terminal utilizes the low frequency signal to search within the first recognition area but doesn't discover the target wearable device, control the mobile terminal utilize a high frequency signal to search within a second recognition area whether there is the target wearable device matching the ID verification code; for detailed description, please see above.

Similarly, in other embodiments, the search can be also initiated at the wearable device side, and the determining module comprises:
a first search control unit, being configured to control the wearable device firstly utilize a low frequency signal to search within the first recognition area whether there is the target mobile terminal that has been performed the ID verification code match; for detailed description, please see above.
a second search control unit, being configured to, when the wearable device utilizes the low frequency signal to search within the first recognition area but doesn't discover the target mobile terminal, control the wearable device utilize a high frequency signal to search within a second recognition area whether there is the target mobile terminal matching the ID verification code; for detailed description, please see above.

As can be concluded, concerning the automatic unlocking method and system for a mobile terminal within a short distance, the mobile terminal detects whether there is a wearable device that has been performed the ID verification code match when its screen is locked, and determines whether the distance between the mobile terminal and the wearable device is within a predetermined distance range when the mobile terminal detects the wearable device that has been performed the ID verification code match, and unlocks and enters the home interface when the distance between the mobile terminal and the wearable device is determined to be within the predetermined distance range. Thus, the mobile terminal is enabled with automatic unlocking function, which eliminates the need of repeated manual unlocking in frequent use of mobile terminals and further allows easy use of mobile terminal for the user who is meanwhile using a wearable device, thereby bringing profound convenience to daily use of mobile terminals.

It should be appreciated that the application of the present disclosure should not be limited to the above examples, which can be improved or transformed by an ordinary technician in the art according to the above description. Any improvement or transformation should all be covered within the protection scope of the appended claims of the present disclosure.

1. An automatic unlocking method for a mobile terminal within a short distance, comprising the following steps:
performing in advance an ID (identity) verification code match between the mobile terminal and a wearable device, for utilizing the wearable device to unlock the mobile terminal;
utilizing by the mobile terminal a low frequency signal to search within a first recognition area whether there is the wearable device that has been performed the ID verification code match when a screen of the mobile terminal is locked;
determining by the mobile terminal whether a distance between the mobile terminal and the wearable device is within a predetermined distance range when the mobile terminal utilizes the low frequency signal to search within the first recognition area that there is the wearable device that has been performed the ID verification code match;
utilizing by the mobile terminal a high frequency signal to search within a second recognition area whether there is the wearable device that has been perform the ID verification code match when the mobile terminal utilizes the low frequency signal to search within the first recognition area that there is not the wearable device that has been performed the ID verification code match;
determining by the mobile terminal whether the distance between the mobile terminal and the wearable device is within the predetermined distance range when the mobile terminal utilizes the high frequency signal to search within the second recognition area that there is the wearable device that has been performed the ID verification code match;
unlocking by the mobile terminal and entering an operation interface when the distance between the mobile terminal and the wearable device is determined to be within the predetermined distance range; and
prompting by the mobile terminal for manual unlocking when the distance between the mobile terminal and the wearable device is determined to be not within the predetermined distance range.

2. The automatic unlocking method for a mobile terminal within a short distance according to claim 1, wherein the predetermined distance range is within 1 meter.

3. The automatic unlocking method for a mobile terminal within a short distance according to claim 1, wherein the wearable device and the mobile terminal perform the ID verification via a Bluetooth sensor.

4. The automatic unlocking method for a mobile terminal within a short distance according to claim 2, wherein the wearable device and the mobile terminal perform the ID verification via a Bluetooth sensor.

5. The automatic unlocking method for a mobile terminal within a short distance according to claim 1, further comprising:
utilizing firstly by the wearable device a low frequency signal to search within a first recognition area whether there is the mobile terminal that has been performed the ID verification code match;
activating the step of determining whether the distance between the mobile terminal and the wearable device is within the predetermined distance range when there is the mobile terminal within the first recognition area that has been performed the ID verification code match;
utilizing by the wearable device a high frequency signal to search within a second recognition area whether there is the mobile terminal matching the ID verification code when there is not the mobile terminal within the first recognition area that has been performed the ID verification code match;
activating the step of determining whether the distance between the mobile terminal and the wearable device is within the predetermined distance range when there is the mobile terminal within the second recognition area that has been performed the ID verification code match;
entering into a standby mode by the wearable device when there is not the mobile terminal within the second recognition area that has been performed the ID verification code match.

6. The automatic unlocking method for a mobile terminal within a short distance according to claim 5, wherein the searching time of the first recognition area is not more than 2 seconds.

7. The automatic unlocking method for a mobile terminal within a short distance according to claim 5, wherein the first recognition area is from 0.2 to 1 meter, and the second recognition area is greater than 1 meter.

8. An automatic unlocking method for a mobile terminal within a short distance, comprising the following steps:
performing in advance an ID verification code match between the mobile terminal and a wearable device, for utilizing the wearable device to unlock the mobile terminal;
detecting by the mobile terminal whether there is the wearable device that has been performed the ID verification code match when a screen of the mobile terminal is locked;
determining by the mobile terminal whether a distance between the mobile terminal and the wearable device is within a predetermined distance range when the mobile terminal detects the wearable device that has been performed the ID verification code match; and
unlocking automatically by the mobile terminal and entering an operation interface when the distance between the mobile terminal and the wearable device is determined to be within the predetermined distance range.

9. The automatic unlocking method for a mobile terminal within a short distance according to claim 8, further comprising, after the step of determining whether the distance between the mobile terminal and the wearable device is within a predetermined distance range:
prompting by the mobile terminal for manual unlocking when the distance between the mobile terminal and the wearable device is determined to be not within the predetermined distance range.

10. The automatic unlocking method for a mobile terminal within a short distance according to claim 8, wherein the predetermined distance range is within 1 meter.

11. The automatic unlocking method for a mobile terminal within a short distance according to claim 8, wherein the wearable device and the mobile terminal perform the ID verification via a Bluetooth sensor.

12. The automatic unlocking method for a mobile terminal within a short distance according to claim 9, wherein the wearable device and the mobile terminal perform the ID verification via a Bluetooth sensor.

13. The automatic unlocking method for a mobile terminal within a short distance according to claim 10, wherein the wearable device and the mobile terminal perform the ID verification via a Bluetooth sensor.

14. The automatic unlocking method for a mobile terminal within a short distance according to claim 8, further comprising:
utilizing firstly by the wearable device a low frequency signal to search within a first recognition area whether there is the target mobile terminal that has been performed the ID verification code match;
activating the step of determining whether the distance between the mobile terminal and the wearable device is within the predetermined distance range when there is the target mobile terminal within the first recognition area that has been performed the ID verification code match;
utilizing by the wearable device a high frequency signal to search within a second recognition area whether there is the target mobile terminal matching the ID verification code when there is not the mobile terminal within the first recognition area that has been performed the ID verification code match;
activating the step of determining whether the distance between the mobile terminal and the wearable device is within the predetermined distance range when there is the mobile terminal within the second recognition area that has been performed the ID verification code match;
entering into a standby mode by the wearable device when there is not the mobile terminal within the second recognition area that has been performed the ID verification code match.

15. The automatic unlocking method for a mobile terminal within a short distance according to claim 14, wherein the searching time of the first recognition area is not more than 2 seconds.

16. The automatic unlocking method for a mobile terminal within a short distance according to claim 14, wherein the first recognition area is from 0.2 to 1 meter, and the second recognition area is greater than 1 meter.

17. An automatic unlocking system for a mobile terminal within a short distance, comprising:
a processor; and
a non-transitory program storage medium, comprising:
a presetting module, being configured to perform in advance an ID verification code match between the mobile terminal and a wearable device, for utilizing the wearable device to unlock the mobile terminal;
a detection module, being configured to, when a screen of the mobile terminal is locked, detect by the mobile terminal whether there is a wearable device that has been performed the ID verification code match;
a determining module, being configured to, when the mobile terminal detects the wearable device that has been performed the ID verification code match, determine whether a distance between the mobile terminal and the wearable device is within a predetermined distance range; and
an automatic unlocking control module, being configured to, when the distance between the mobile terminal and the wearable device is within the predetermined distance range, unlock by the mobile terminal and enter an operation interface.

18. The automatic unlocking system for a mobile terminal within a short distance according to claim 17, further comprising:
a manual unlocking control module, being configured to, when the distance between the mobile terminal and the wearable device is determined to be not within the predetermined distance range, prompt by the mobile terminal for manual unlocking;
wherein the predetermined distance range is within 1 meter.

19. The automatic unlocking system for a mobile terminal within a short distance according to claim 17, wherein the determining module comprises:
a first search control unit, being configured to control the wearable device firstly utilize a low frequency signal to search within a first recognition area whether there is the target mobile terminal that has been performed the ID verification code match;
a second search control unit, being configured to, when the wearable device utilizes the low frequency signal to search within the first recognition area but doesn't discover the target mobile terminal, control the wearable device utilize a high frequency signal to search within a second recognition area whether there is the target mobile terminal matching the ID verification code.
